(19) United States
(12) Patent Application Publication
(10) Pub. No.: US 2026/0301040 A1
(43) Pub. Date: Oct. 1, 2026

(54) METHOD AND APPARATUS FOR GENERATING OBJECT COMBINATION, ELECTRONIC DEVICE, AND READABLE MEDIUM

(71) Applicant: Beijing Youzhuju Network Technology Co., Ltd., Beijing (CN)

(72) Inventors: Zhixin SHEN, Beijing (CN); Jianchao SUN, Beijing (CN); Yue YAN, Beijing (CN); Chen MA, Beijing (CN)

(21) Appl. No.: 19/490,889

(22) PCT Filed: Sep. 23, 2024
(86) PCT No.: PCT/CN2024/120463

§ 371 Date: Dec. 5, 2025

(30) Foreign Application Priority Data
Sep. 27, 2023 (CN) 202311262662.1

(51) Int. Cl. G06Q 30/0601; G06F 16/28

(52) U.S. Cl. CPC G06Q 30/0629; G06F 16/285

(57) ABSTRACT

Embodiments of the present disclosure provide a method for invoking an end plugin, a device, a storage medium, and a computer program product. The method includes: sending a target request to a target model, the target request involving invoking a target end plugin; receiving, from a long-link service, an invocation command for the target end plugin according to a preset communication protocol, the invocation command being generated based on an invocation request received from the target model and the preset communication protocol; and executing the target end plugin according to the invocation command.

### CROSS-REFERENCE TO RELATED APPLICATION(S)

The present application claims priority to Chinese Patent Application No. 202311262662.1, filed with the China National Intellectual Property Administration on Sep. 27, 2023 and entitled “METHOD AND APPARATUS FOR GENERATING OBJECT COMBINATION, ELECTRONIC DEVICE, AND READABLE MEDIUM”, which is incorporated herein by reference in its entirety.

### FIELD

The present application relates to the field of computer technology, and in particular to a method and apparatus for generating an object combination, an electronic device and a readable medium.

### BACKGROUND

With the development of Internet technology, people can perform operations on online objects through online behaviors, and staff can also display objects better to people through editing, management, and other behaviors. For example, staff of an online store can display products and/or services in the online store through editing, management, and other behaviors, and users can browse, favorite or purchase the products and/or services in the online store.

Currently, staff can manually bundle a plurality of online objects into an object combination on an online management platform (hereinafter referred to as a management platform) and display the object combination to people, so that people can browse, view, and even purchase the object combination online.

### SUMMARY

In order to solve the technical problems described above, the present application provides a method and apparatus for generating an object combination, an electronic device, and a readable medium, which can automatically and intelligently generate object combinations. This not only facilitates staff, but also ensures the quality of automatically generated object combinations, making it possible to optimize online marketing.

To achieve the above objective, the present application provides the following technical solutions.

According to a first aspect, the present application provides a method for generating an object combination. The method includes:
determining, based on category information of each object, a category to which each object belongs; and
generating at least one object combination based on a category association relationship database and the category to which each object belongs, where each category association relationship in the category association relationship database includes at least two categories that satisfy a combination condition and that are determined based on historical interaction result information, the interaction result information is used to reflect historical interactions between the at least two categories, and categories to which at least two objects included in each of the at least one object combination belong match a category association relationship in the category association relationship database.

In a possible implementation, the category association relationship database includes a first category association relationship, the first category association relationship includes a first category and a second category, and generating the at least one object combination based on the category association relationship database and the category to which each object belongs includes:
determining a first object set that consists of objects belonging to the first category among objects;
determining a second object set that consists of objects belonging to the second category among the objects; and
generating, based on the first object set and the second object set, the at least one object combination, where each of the at least one object combination includes any object in the first object set and any object in the second object set.

In a possible implementation, a construction process of the category association relationship database includes:
obtaining interaction result information corresponding to a third category based on an interaction behavior between an object of the third category and an object of other categories, where the interaction result information corresponding to the third category includes a number of forward interactions and a reverse interaction ratio between the third category and the other categories, the forward interaction refers to that an interaction corresponding to the object belonging to the third category that occurs for a same user is within a preset time period before an interaction corresponding to the object belonging to the other categories that occurs for the user, and that the interaction corresponding to the object belonging to the third category and the interaction corresponding to the object belonging to the other categories are two adjacent interaction behaviors, the reverse interaction ratio refers to a ratio of a number of times that a previous interaction behavior before the interaction corresponding to the object belonging to the other categories occurs is the interaction behavior corresponding to the object belonging to the third category to a number of times that the interaction behavior corresponding to the object belonging to the third category occurs, and an interval time between the time at which the interaction corresponding to the object belonging to the other categories occurs and the time at which the interaction corresponding to the object belonging to the third category occurs is less than or equal to the preset time;
determining, based on the number of forward interactions and the reverse interaction ratio, a fourth category that satisfies the combination condition with the third category, where the fourth category belongs to at least one of the other categories; and
recording the third category with each fourth category as a category association relationship in the category association relationship database.

As an example, determining, based on the number of forward interactions and the reverse interaction ratio, a fourth category that satisfies the combination condition with the third category includes:
determining, based on the number of forward interactions and the reverse interaction ratio, an association weight between the third category and each of the other categories; and
determining, based on the association weights of the other categories, the fourth category that satisfies the combination condition, where the combination condition includes: a preset number of the other categories with highest association weights, or determining the other categories that have association weights greater than a preset weight threshold as the fourth category.

As another example, determining, based on the association weights of the other categories, the fourth category that satisfies the combination condition includes:
determining, if a fifth category for which the ratio is greater than or equal to a preset ratio threshold exists among the other categories, the fourth category that satisfies the combination condition from the fifth category.

In a possible implementation, objects in the at least one object combination all belong to a same entity.

In a possible implementation, the method further includes:
determining, based on a degree of association of each of the at least one object combination, a bundle score for each of the at least one object combination, where the degree of association of the object combination represents a ratio or number of times that objects belonging to the object combination within the target entity are combined for marketing, and the bundle score is used to guide display and/or release of a corresponding object combination.

According to a second aspect, the present application further provides an apparatus for generating an object combination. The apparatus includes:
a determination unit configured to determine, based on category information of each object, a category to which each object belongs; and
a generation unit configured to generate at least one object combination based on a category association relationship database and the category to which each object belongs, where each category association relationship in the category association relationship database includes at least two categories that satisfy a combination condition and that are determined based on historical interaction result information, the interaction result information is used to reflect historical interactions between the at least two categories, and categories to which at least two objects included in each of the at least one object combination belong match a category association relationship in the category association relationship database.

In a possible implementation, the category association relationship database includes a first category association relationship, and the first category association relationship includes a first category and a second category. The generation unit includes:
a first determination subunit configured to determine a first object set that consists of objects belonging to the first category among objects;
a second determination subunit configured to determine a second object set that consists of objects belonging to the second category among the objects; and
a generation subunit configured to generate, based on the first object set and the second object set, the at least one object combination, where each of the at least one object combination includes any object in the first object set and any object in the second object set.

In a possible implementation, the apparatus further includes: a construction unit configured to:
construct the category association relationship database.

As an example, the construction unit includes:
a first obtaining subunit configured to obtain interaction result information corresponding to a third category based on an interaction behavior between an object of the third category and an object of other categories, where the interaction result information corresponding to the third category includes a number of forward interactions and a reverse interaction ratio between the third category and the other categories, the forward interaction refers to that an interaction corresponding to the object belonging to the third category that occurs for a same user is within a preset time period before an interaction corresponding to the object belonging to the other categories that occurs for the user, and that the interaction corresponding to the object belonging to the third category and the interaction corresponding to the object belonging to the other categories are two adjacent interaction behaviors, the reverse interaction ratio refers to a ratio of a number of times that a previous interaction behavior before the interaction corresponding to the object belonging to the other categories occurs is the interaction behavior corresponding to the object belonging to the third category to a number of times that the interaction behavior corresponding to the object belonging to the third category occurs, and an interval time between the time at which the interaction corresponding to the object belonging to the other categories occurs and the time at which the interaction corresponding to the object belonging to the third category occurs is less than or equal to the preset time;
a third determination subunit configured to determine, based on the number of forward interactions and the reverse interaction ratio, a fourth category that satisfies the combination condition with the third category, where the fourth category belongs to at least one of the other categories; and
a save subunit configured to record the third category with each fourth category as a category association relationship in the category association relationship database.

As an example, the third determination subunit includes:
a first determination module configured to determine, based on the number of forward interactions and the reverse interaction ratio, an association weight between the third category and each of the other categories; and
a second determination module configured to determine, based on the association weights of the other categories, the fourth category that satisfies the combination condition, where the combination condition includes: a preset number of the other categories with highest association weights, or determining the other categories that have association weights greater than a preset weight threshold as the fourth category.

As another example, the second determination module is specifically configured to:
determine, if a fifth category for which the ratio is greater than or equal to a preset ratio threshold exists among the other categories, the fourth category that satisfies the combination condition from the fifth category.

In a possible implementation, objects in the at least one object combination all belong to a same entity.

In a possible implementation, the apparatus further includes:
a scoring unit configured to determine, based on a degree of association of each of the at least one object combination, a bundle score for each of the at least one object combination, where the degree of association of the object combination represents a ratio or number of times that objects belonging to the object combination within the target entity are combined for marketing, and the bundle score is used to guide display and/or release of a corresponding object combination.

It should be noted that specific implementation of the apparatus and the technical effect achieved can be found in related description of the method provided in the first aspect or any of the implementations of the first aspect.

According to a third aspect, the present application further provides an electronic device. The electronic device includes: a processor and a memory, where
the memory is configured to store instructions or a program; and
the processor is configured to execute the instructions or the program in the memory, to cause the electronic device to perform the method provided in the first aspect or any of the implementations of the first aspect.

According to a fourth aspect, the present application further provides a readable medium having instructions or a program stored therein that, when executed on a processor, causes the processor to perform the method provided in the first aspect or any of the implementations of the first aspect.

### BRIEF DESCRIPTION OF THE DRAWINGS

In order to more clearly describe the technical solutions in the embodiments of the present application or in the related art, the drawings for describing the embodiments or the prior art will be briefly described below. Apparently, the drawings in the description below show merely some embodiments recited in the present application, and persons of ordinary skill in the art may still derive other drawings from these drawings without creative efforts.

FIG. 1 is a schematic flowchart of a method for generating an object combination according to embodiments of the present application;

FIG. 2 is a schematic flowchart of constructing a category association relationship database according to embodiments of the present application;

FIG. 3 is a schematic structural diagram of an apparatus 300 for generating an object combination according to embodiments of the present application; and

FIG. 4 is a schematic structural diagram of an electronic device 400 according to embodiments of the present application.

### DETAILED DESCRIPTION OF EMBODIMENTS

In some cases, users want to view and purchase a plurality of objects that have a specific relationship through an online entity. For the convenience of the users, the online entity usually displays a plurality of objects in close proximity or as an object combination to the users. A scenario in which the online entity displays the plurality of objects as the object combination to the users may be understood as the online entity performing a bundling operation on the plurality of objects. For example, an online store may bundle products such as maternity pads, maternity hats, and maternity slippers into a hospital bag. For another example, an online store may bundle a shirt and suit trousers into a commuting outfit set.

Currently, staff can manually bundle a plurality of online objects into an object combination on an online management platform (hereinafter referred to as a management platform) and display the object combination to people, so that people can browse, view, and even purchase the object combination online. However, the manual bundling of object combinations by the staff is not convenient for the staff, and bundled object combinations are of varying quality, making it impossible to achieve a goal of optimizing online marketing by bundling object combinations.

Staff of the online entity usually manually enters bundled object combinations on an operating platform of the online entity, based on their own experience or sales data of each object. For example, the operating platform of the online store is provided with a “Product Bundling” function. The staff enters an editing page through “Create New Bundle”, then creates a bundled combination on the editing page by uploading a main bundle image, adding products, or other operations. After being approved, the bundled combination can be released and listed for the users to view and/or purchase. Although it is convenient for the users to view and/or purchase on the online entity, this process is not very friendly to the staff of the online entity. On the one hand, the staff is required to think of objects to bundle and perform complex editing operations and other operations. On the other hand, the quality of object combinations generated through manual object bundling by the staff cannot be guaranteed. In many cases, object combinations provided cannot meet the users' needs. Therefore, current methods for bundling objects are time-consuming, labor-intensive, and bring little effect.

In view of this, embodiments of the present application provide a method for generating an object combination. Taking a management platform of the online entity as an example, an automatic bundling function is integrated into a backend of the management platform, so that the management platform can provide the automatic bundling function for the staff of the online entity. Taking a case where the staff of the online entity requires automatic bundling as an example, an apparatus for generating an object combination may first determine, based on category information of each object, a category to which each object belongs; and then, generate at least one object combination based on a category association relationship database and the category to which each object belongs, where each category association relationship in the category association relationship database includes at least two categories that satisfy a combination condition and that are determined based on historical interaction result information, the interaction result information is used to reflect historical interactions between the at least two categories, and categories to which at least two objects included in each of the at least one object combination belong match a category association relationship in the category association relationship database.

In this way, there is no need for the staff to manually perform object bundling. Due to the automatic bundling function integrated in the backend of the management platform, only by using the automatic bundling function by the staff, the management platform can construct and maintain a category association relationship database based on historical interactions between at least two categories as reflected by historical interaction result information, and automatically determine an object combination based on a matching result between the category to which each object belongs and the category association relationship database. On the other hand, this achieves the purpose of automatically generating object combinations. On the other hand, since the category association relationship database is determined based on the historical interaction result information, the category association relationship database is used as a matching reference, and is a reliable data base, which makes the quality of generated object combinations better, and thus, makes it possible to optimize online marketing.

It should be noted that the management platform of the online entity may be: a management platform page that the online entity can operate after logging in on the management platform provided by an e-commerce enterprise hosting the online entity. The management platform may be in the form of a client or a web page.

It should be noted that an entity implementing the method for generating an object combination may be an apparatus for generating an object combination provided in the embodiments of the present application. The apparatus for generating an object combination may be carried in an electronic device or in a functional module of an electronic device. Taking the scenario of the management platform of the online entity as an example, the apparatus for generating an object combination may include the management platform of the online entity, or the apparatus for generating an object combination may be connected to the management platform of the online entity. The electronic device may be installed with a client corresponding to the management platform of the online entity, or may access a web page corresponding to the management platform of the online entity.

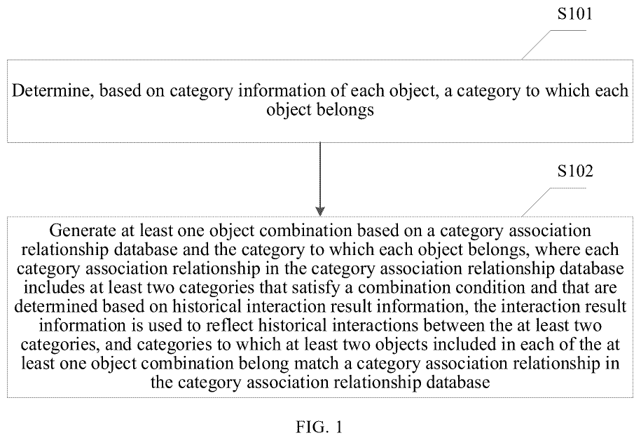

FIG. 1 is a schematic flowchart of a method for generating an object combination according to embodiments of the present application. The method may be applied to an apparatus for generating an object combination, such as an apparatus 300 for generating an object combination shown in FIG. 3 below. In the scenario of the management platform of the online entity, the apparatus for generating an object combination may include or be connected to the management platform of the online entity. Therefore, it can also be considered that the method may be applied to the management platform of the online entity.

As shown in FIG. 1, the method may include the following steps S101 to S102.

S101: a category to which each object belongs is determined based on category information of each object.

It can be understood that the method may automatically bundle objects within an entity, then the objects in S101 may refer to all or some of objects within a target entity. If the objects in S101 are some of the objects within the target entity, the method may further include: selecting objects from all objects within the target entity to participate in automatic bundling, where the selection may be based on one or more pieces of historical information of the objects, such as sales volume, a number of views, and a number of favorites.

In these embodiments of the present application, an operation item corresponding to an automatic bundling function is provided on the management platform of the online entity. When staff performs an action on the operation item, it is considered that a target operation is performed on the management platform. The performance of the target operation triggers the backend of the management platform to automatically perform object bundling for a target entity corresponding to the staff. For example, an interface corresponding to the management platform of the online entity may include an “Intelligent Bundle Recommendation” button. The “Intelligent Bundle Recommendation” button may correspond to the operation item corresponding to the automatic bundling function on the management platform of the online entity. When a user clicks on the “Intelligent Bundle Recommendation” button, it is equivalent to performing the target operation on the management platform, thereby triggering the management platform to implement the method.

During the process of the backend of the management platform automatically performing object bundling for the target entity, it is necessary to first obtain the category information of each object within the target entity as the data basis for bundling. The category information may refer to information that can indicate a category to which an object belongs. For example, the category information may be a name of a category or a number of a category. For example, category information of a lipstick may be “makeup”, so that it may be determined that the lipstick belongs to a category of “makeup”. For another example, the category information of the lipstick may also be “001”, where “001” is a category number for “makeup”, so that it may be determined that the lipstick belongs to the category of “makeup”.

S102: at least one object combination is generated based on a category association relationship database and the category to which each object belongs, where each category association relationship in the category association relationship database includes at least two categories that satisfy a combination condition and that are determined based on historical interaction result information, the interaction result information is used to reflect historical interactions between the at least two categories, and categories to which at least two objects included in each of the at least one object combination belong match a category association relationship in the category association relationship database.

In a possible implementation, S102 may include, for example: inputting the category of each object included in the target entity into a bundling algorithm, which outputs at least one object combination of the target entity. The bundling algorithm may include the category association relationship database.

Taking an online entity as an example, objects involved in at least one object combination belong to a same online entity (i.e., the target entity). The online entity may refer to a store in an e-commerce enterprise, the objects may correspond to products and/or services in the store, and the object combination is a combination of at least two products and/or services in the store. For example, the target entity corresponds to flagship store B of e-commerce enterprise A, the objects refer to products a1, a2, . . . , a100 in flagship store B, then the object combination may be a combination formed by bundling at least two objects among a1, a2, . . . , a100, such as a1+a3+a100, a2+a30, or a5+a33+a100, all of which may be considered as an object combination of the target entity B.

The category association relationship database may be a database that is pre-constructed and maintained prior to performing S102 based on the historical interaction result information and the combination condition, and that includes a plurality of category association relationships. Each category association relationship includes at least two categories, and the category association relationship database is used to indicate at least two categories with a bundling association to determine categories within the target entity that may be combined, thereby determining possible object combinations within the target entity. According to an analysis of the historical interaction result information, there is a strong association between a plurality of categories of the same category association relationship, and there is a high probability of interaction. For example, a shirt, suit trousers, and leather shoes may be included in a category association relationship, the association being reflected as a professional suit. For another example, a T-shirt and a skirt may be included in another category association relationship, the association being reflected as a common outfit. However, a vest and cotton shoes may not be maintained in a category association relationship.

The historical interaction result information is determined by performing statistical analysis based on historical interaction behavior data of each user, and reflects historical interactions between at least two categories. The historical interactions may include the frequency and accuracy of historical interactions. For example, a process of determining the interaction result information may include: for each user, performing statistics and analysis on historical interaction behavior of objects belonging to different categories, to obtain interaction behavior sub-results of the user; and combining the interaction behavior sub-results of each user to obtain the interaction result information.

As an example, taking a case where the category association relationship database includes a first category association relationship, and the first category association relationship includes a first category and a second category as an example, S102 may include, for example: determining a first object set that consists of objects belonging to the first category among objects; determining a second object set that consists of objects belonging to the second category among the objects; and generating, based on the first object set and the second object set, the at least one object combination, where each of the at least one object combination includes any object in the first object set and any object in the second object set. For example, objects belonging to the first category within the target entity include an object A, an object B, and an object C, and objects belonging to the second category within the target entity include an object D, an object E, an object F, and an object G, then the generated object combination may include: an object combination 1 {object A, object D}, an object combination 2 {object A, object E}, an object combination 3 {object A, object F}, an object combination 4 {object A, object G}, an object combination 5 {object B, object D}, an object combination 6 {object B, object E}, an object combination 7 {object B, object F}, an object combination 8 {object B, object G}, an object combination 9 {object C, object D}, an object combination 10 {object C, object E}, an object combination 11 {object C, object F}, and an object combination 12 {object C, object G}.

As another example, taking a case where the category association relationship database includes a second category association relationship, and the second category association relationship includes a first category, a second category, and a third category as an example, S102 may include, for example: determining a first object set that consists of objects belonging to the first category among objects; determining a second object set that consists of objects belonging to the second category among the objects; determining a third object set that consists of objects belonging to the third category among the objects; and generating, based on at least two of the first object set, the second object set, or the third object set, the at least one object combination, where each of the at least one object combination includes any object in each of the at least two object sets participating in the combination. For example, objects belonging to the first category within the target entity include an object A and an object B, objects belonging to the second category within the target entity include an object C, and objects belonging to the third category within the target entity include an object D and an object E, then, the generated object combination may include: an object combination 1 {object A, object C}, an object combination 2 {object B, object C}, an object combination 3 {object A, object D}, an object combination 4 {object A, object E}, an object combination 5 {object B, object D}, an object combination 6 {object B, object E}, an object combination 7 {object C, object D}, an object combination 8 {object C, object E}, an object combination 9 {object A, object C, object D}, an object combination 10 {object A, object C, object E} , an object combination 11 {object B, object C, object D}, and an object combination 12 {object B, object C, object E}.

In some implementations, during the process of constructing the category association relationship database, it is necessary to use a full order database of the online platform as a data source to perform a statistical analysis on orders over a preset period in the past. The longer the preset period, the richer the data base involved in constructing the category association relationship database, the more informative the interaction result information obtained through analysis, and the more reliable the resulting category association relationship database. Therefore, as an example, it is possible to perform a statistical analysis on orders over all times in the past. In addition, orders that participate in the statistics may be any order or, for the sake of more accurate statistics, normal payment orders selected from all orders that have not been canceled and have not been applied for after-sales service.

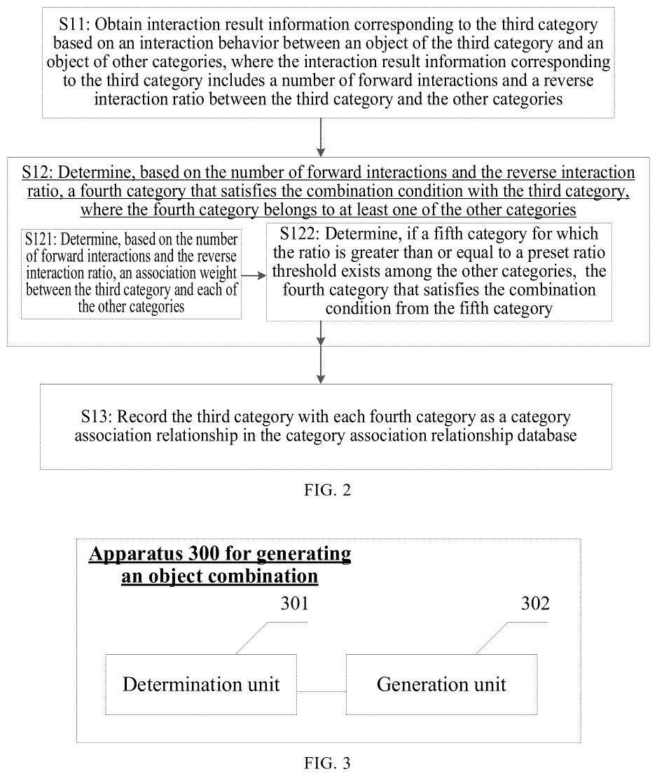

The construction process of the category association relationship database can be seen in FIG. 2, and includes: S11: obtaining interaction result information corresponding to the third category based on an interaction behavior between an object of the third category and an object of other categories, where the interaction result information corresponding to the third category includes a number of forward interactions and a reverse interaction ratio between the third category and the other categories, the forward interaction refers to that an interaction corresponding to the object belonging to the third category that occurs for a same user is within a preset time period before an interaction corresponding to the object belonging to the other categories that occurs for the user, and that the interaction corresponding to the object belonging to the third category and the interaction corresponding to the object belonging to the other categories are two adjacent interaction behaviors, the reverse interaction ratio refers to a ratio of a number of times that a previous interaction behavior before the interaction corresponding to the object belonging to the other categories occurs is the interaction behavior corresponding to the object belonging to the third category to a number of times that the interaction behavior corresponding to the object belonging to the third category occurs, and an interval time between the time at which the interaction corresponding to the object belonging to the other categories occurs and the time at which the interaction corresponding to the object belonging to the third category occurs is less than or equal to the preset time; S12: determining, based on the number of forward interactions and the reverse interaction ratio, a fourth category that satisfies the combination condition with the third category, where the fourth category belongs to at least one of the other categories; and S13: Record the third category with each fourth category as a category association relationship in the category association relationship database. S12 may include, for example: S121: determining, based on the number of forward interactions and the reverse interaction ratio, an association weight between the third category and each of the other categories; and S122: determining, based on the association weights of the other categories, the fourth category that satisfies the combination condition, where the combination condition may include, for example: a preset number of the other categories with highest association weights, or determining the other categories that have association weights greater than a preset weight threshold as the fourth category. As an example, S122 may include, for example: determining, if a fifth category for which the ratio is greater than or equal to a preset ratio threshold exists among the other categories, the fourth category that satisfies the combination condition from the fifth category.

A size of the association weight may reflect a rationality of a combination of the category bundle.

For example, taking a case where the object is a product as an example, if the same user purchases a B-category product within a preset time (e.g., 24 hours) after purchasing an A-category product, and the user does not purchase any other product between the purchases of the A-category product and the B-category product (that is, purchase behaviors of the A-category product and the B-category product are two adjacent purchase behaviors), it is considered that there is an A-B category bundle. Then, on the one hand, in order to be able to analyze the frequency of category bundling, the number of forward interactions of the A-B category bundle (i.e., the number of times that the same user purchases a B-category product within a preset time after purchasing an A-category product, and the user does not purchase any other product between the purchases of the A-category product and the B-category product) may be calculated based on all purchase records for all users over the entire statistical time. On the other hand, in order to make the resulting category association relationship more accurate, it is necessary to exclude products purchased by universal bundling. Therefore, the reverse interaction ratio of the A-B category bundle may also be calculated based on all purchase records for all users over the entire statistical time. That is, if the number of times to purchase the B-category product is 100, and the number of times to purchase the A-category product within a preset time before purchasing the B-category product with no other product being purchased between the purchases of the A-category product and the B-category product is 50, the reverse interaction ratio of the A-B category bundle is determined to be 50%. In this way, a product of the number of forward interactions and the reverse interaction ratio may be denoted as the association weight of the A-B category bundle. Based on the above-mentioned manner, association weights of category bundles A-B, A-C, . . . , A-Z may be determined. Then, it may first be determined whether reverse interaction ratios of the category bundles are greater than a preset threshold (e.g., 1%). If the reverse interaction ratios are greater than the preset threshold, a preset number (e.g., 20) of category bundles with highest association weights are selected from the category bundles whose reverse interaction ratios are greater than the preset threshold, and the selected category bundles are each recorded as a category association relationship, and maintained in the category association relationship database. If none of the reverse interaction ratios of the category bundles is greater than the preset threshold, a preset number of category bundles with highest association weights are selected from all the category bundles, and the selected category bundles are each recorded as a category association relationship, and maintained in the category association relationship database.

It should be noted that category association relationships in the category association relationship database may be updated regularly or irregularly in order to provide an accurate data basis for the process of automatically generating object combinations at any time.

A least one object combination generated based on the category association relationship database may be maintained in a table, which may include at least: an identifier (ID) of a category A, an ID of a category B and the association weight of the “the A-B category bundle”. For ease of viewing, the table may further include a name of the category A and/or a name of the category B.

It can be understood that after at least one object combination of the target entity is generated, the at least one object combination of the target entity may be saved in the form of a file for the staff of the target entity to view, edit and perform other operations.

In some possible implementations, in order to subsequently optimize the process of automatic bundling, and to provide a better experience for online entities, the method may further include: calculating a degree of association of the object combination based on a number of views, sales volume, buyer evaluations, staff evaluations in the object combination of the target entity, sales associations of the objects in the object combination, etc., and determining a bundle score of the object combination based on the degree of association. Optionally, the bundle score may be displayed on the management platform to guide the display and/or release of the object combinations. For example, the staff may choose to list object combinations with higher bundle scores. For another example, the staff may choose to “one-click adjust” a display order of the object combinations on a display page of the online entity according to their bundle scores. Even the staff member may set a bundle score threshold for display, where an object combination with a bundle score below the bundle score threshold will not be displayed on the display page. For yet another example, the staff may also influence the bundle scores of object combinations by filling in evaluations.

It should be noted that the at least one object combination generated in S102 may be an object combination that has undergone de-duplication of same combinations and/or same-category filtering in a bundle. Alternatively, the at least one object combination generated in S102 may be an object combination that has not undergone de-duplication of same combinations and/or same-category filtering in a bundle. In this case, after S102, the method may further perform the de-duplication of same combinations and/or same-category filtering in a bundle, to improve the quality of the object combinations that are ultimately provided to the staff of the target entity, and improve the user's experience of using the automatic bundling function.

As can be seen, in this method, there is no need for the staff to manually perform object bundling. Due to the automatic bundling function integrated in the backend of the management platform, only by using the automatic bundling function by the staff, the management platform can construct and maintain a category association relationship database based on historical interactions between at least two categories as reflected by historical interaction result information, and automatically determine an object combination based on a matching result between the category to which each object belongs and the category association relationship database. On the other hand, this achieves the purpose of automatically generating object combinations. On the other hand, since the category association relationship database is determined based on the historical interaction result information, the category association relationship database is used as a matching reference, and is a reliable data base, which makes the quality of generated object combinations better, and thus, makes it possible to optimize online marketing.

Correspondingly, embodiments of the present application further provide an apparatus 300 for generating an object combination, as shown in FIG. 3. The apparatus 300 may include:
a determination unit 301 configured to determine, based on category information of each object, a category to which each object belongs; and
a generation unit 302 configured to generate at least one object combination based on a category association relationship database and the category to which each object belongs, where each category association relationship in the category association relationship database includes at least two categories that satisfy a combination condition and that are determined based on historical interaction result information, the interaction result information is used to reflect historical interactions between the at least two categories, and categories to which at least two objects included in each of the at least one object combination belong match a category association relationship in the category association relationship database.

In a possible implementation, the category association relationship database includes a first category association relationship, and the first category association relationship includes a first category and a second category. The generation unit 302 includes:
a first determination subunit configured to determine a first object set that consists of objects belonging to the first category among objects;
a second determination subunit configured to determine a second object set that consists of objects belonging to the second category among the objects; and
a generation subunit configured to generate, based on the first object set and the second object set, the at least one object combination, where each of the at least one object combination includes any object in the first object set and any object in the second object set.

In a possible implementation, the apparatus 300 further includes: a construction unit configured to: construct the category association relationship database.

As an example, the construction unit includes:
a first obtaining subunit configured to obtain interaction result information corresponding to a third category based on an interaction behavior between an object of the third category and an object of other categories, where the interaction result information corresponding to the third category includes a number of forward interactions and a reverse interaction ratio between the third category and the other categories, the forward interaction refers to that an interaction corresponding to the object belonging to the third category that occurs for a same user is within a preset time period before an interaction corresponding to the object belonging to the other categories that occurs for the user, and that the interaction corresponding to the object belonging to the third category and the interaction corresponding to the object belonging to the other categories are two adjacent interaction behaviors, the reverse interaction ratio refers to a ratio of a number of times that a previous interaction behavior before the interaction corresponding to the object belonging to the other categories occurs is the interaction behavior corresponding to the object belonging to the third category to a number of times that the interaction behavior corresponding to the object belonging to the third category occurs, and an interval time between the time at which the interaction corresponding to the object belonging to the other categories occurs and the time at which the interaction corresponding to the object belonging to the third category occurs is less than or equal to the preset time;
a third determination subunit configured to determine, based on the number of forward interactions and the reverse interaction ratio, a fourth category that satisfies the combination condition with the third category, where the fourth category belongs to at least one of the other categories; and
a save subunit configured to record the third category with each fourth category as a category association relationship in the category association relationship database.

As an example, the third determination subunit includes:
a first determination module configured to determine, based on the number of forward interactions and the reverse interaction ratio, an association weight between the third category and each of the other categories; and
a second determination module configured to determine, based on the association weights of the other categories, the fourth category that satisfies the combination condition, where the combination condition includes: a preset number of the other categories with highest association weights, or determining the other categories that have association weights greater than a preset weight threshold as the fourth category.

As another example, the second determination module is specifically configured to:
determine, if a fifth category for which the ratio is greater than or equal to a preset ratio threshold exists among the other categories, the fourth category that satisfies the combination condition from the fifth category.

In a possible implementation, objects in the at least one object combination all belong to a same entity.

In a possible implementation, the apparatus 300 further includes:
a scoring unit configured to determine, based on a degree of association of each of the at least one object combination, a bundle score for each of the at least one object combination, where the degree of association of the object combination represents a ratio or number of times that objects belonging to the object combination within the target entity are combined for marketing, and the bundle score is used to guide display and/or release of a corresponding object combination.

It should be noted that specific implementation of the apparatus 300 and the technical effect achieved can be found in related description of the method shown in FIG. 1.

In addition, embodiments of the present application further provide an electronic device. The device includes a processor and a memory. The memory is configured to store instructions or a computer program. The processor is configured to execute the instructions or computer program in the memory to cause the electronic device to perform any implementation of the method according to the embodiments of the present application.

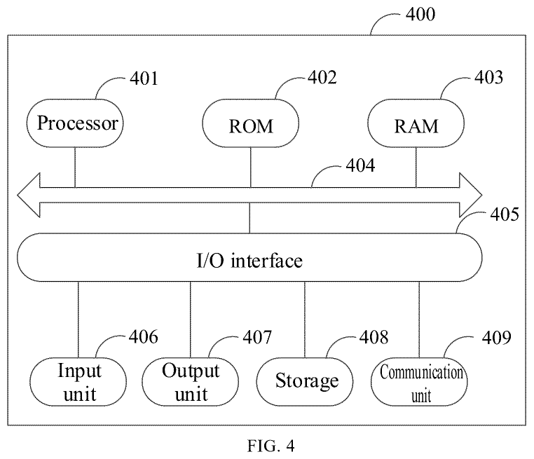

Reference is made to FIG. 4, which is a schematic structural diagram of an electronic device 400 suitable for implementing embodiments of the present disclosure. A terminal device in these embodiments of the present disclosure may include, but is not limited to, mobile terminals such as a mobile phone, a notebook computer, a digital broadcast receiver, a personal digital assistant (PDA), a PAD (tablet computer), a portable multimedia player (PMP), and a vehicle-mounted terminal (e.g., a vehicle navigation terminal), and fixed terminals such as a digital TV and a desktop computer. The electronic device shown in FIG. 4 is merely an example, and shall not impose any limitation on the function and scope of use of the embodiments of the present disclosure.

As shown in FIG. 4, the electronic device 400 may include a processor (for example, a central processing unit or a graphics processing unit) 401 that may perform a variety of appropriate actions and processing in accordance with a program stored in a read-only memory (ROM) 402 or a program loaded from a storage 408 into a random-access memory (RAM) 403. The RAM 403 further has various programs and data required for operations of the electronic device 400 stored therein. The processor 401, the ROM 402, and the RAM 403 are connected to one another through a bus 404. An input/output (I/O) interface 405 is also connected to the bus 404.

Generally, the following means may be connected to the I/O interface 405: an input unit 406 including, for example, a touchscreen, a touchpad, a keyboard, a mouse, a camera, a microphone, an accelerometer, and a gyroscope; an output unit 407 including, for example, a liquid crystal display (LCD), a speaker, and a vibrator; the storage 408 including, for example, a magnetic tape and a hard disk drive; and a communication unit 409. The communication unit 409 may allow the electronic device 400 to perform wireless or wired communication with other devices to exchange data. Although FIG. 4 shows the electronic device 400 having various means, it should be understood that it is not required to implement or have all of the shown means. It may be an alternative to implement or have more or fewer means.

In particular, according to the embodiments of the present disclosure, the process described above with reference to the flowchart may be implemented as a computer software program. For example, embodiments of the present disclosure include a computer program product, which includes a computer program carried on a non-transitory computer-readable medium, where the computer program includes program code for performing the method shown in the flowchart. In such embodiments, the computer program may be downloaded and installed from a network through the communication unit 409, installed from the storage 408, or installed from the ROM 402. When the computer program is executed by the processor 401, the above-mentioned functions defined in the method of the embodiments of the present disclosure are performed.

The electronic device according to these embodiments of the present disclosure and the method according to the above-mentioned embodiments belong to the same inventive concept. For the technical details not exhaustively described in these embodiments, reference may be made to the above-mentioned embodiments, and these embodiments and the above-mentioned embodiments have the same beneficial effects.

Embodiments of the present application further provide a computer-readable medium. The computer-readable medium has instructions or a computer program stored therein that, when executed on a device, cause the device to perform any implementation of the method provided in the embodiments of the present application.

It should be noted that the above-mentioned computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk drive, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), and the like, or any suitable combination thereof.

In some implementations, a client or a server may perform communication by using any currently known or future-developed network protocol such as a hypertext transfer protocol (HTTP), and may interconnect with digital data communication (e.g., a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above-mentioned computer-readable medium may be included in the above-mentioned electronic device. Alternatively, the computer-readable medium may exist independently, without being assembled into the electronic device.

The above computer-readable medium carries one or more programs that, when executed by the electronic device, cause the electronic device to perform the above-mentioned method.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. The name of the unit/module does not constitute a limitation on the unit itself under certain circumstances.

The functions described herein above may be performed at least partially by one or more hardware logic components. For example, without limitation, example types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk drive, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

It should be noted that the various embodiments in this specification are described in a progressive manner, and each embodiment focuses on differences from other embodiments. The same or similar parts between the various embodiments may be referenced to each other. For the system or apparatus disclosed in these embodiments, since it corresponds to the method disclosed in the embodiments, the description is relatively simple, and for the related parts, reference may be made to the description of the method.

It should be understood that, in the present application, “at least one” means one or more, and “a plurality of” means two or more. The term “and/or” is used to describe an association relationship between associated objects, and indicates that three relationships may exist, for example, A and/or B may indicate that: only A exists, only B exists, and both A and B exist, where A or B may be singular or plural. The character “/” generally indicates an “or” relationship between the associated objects. “At least one of the following” or similar expressions refers to any combination of these items, including any combination of single items or plural items. For example, at least one of a, b, or c may indicate: a, b, c, “a and b”, “a and c”, “b and c”, or “a and b and c”, where a, b, or c may be singular or plural.

It should also be noted that, herein, relative terms such as “first” and “second” are only used to distinguish one entity or operation from another entity or operation, and do not necessarily require or imply that such an actual relationship or order exists between these entities or operations. Moreover, the terms “include”, “including”, “comprise” and “comprising”, or any of their variants are intended to cover a non-exclusive inclusion, so that a process, method, article, or device that includes a list of elements not only includes those elements but also includes other elements that are not expressly listed, or further includes elements inherent to such process, method, article, or device. In the absence of more restrictions, an element defined by “including/comprising a/an . . . ” does not exclude another identical element in a process, method, article, or device that includes the element.

The steps of the method or algorithm described in conjunction with the embodiments disclosed herein may be implemented directly in hardware, in a software module executed by a processor, or in a combination of the two. The software module may be disposed in a random access memory (RAM), a memory, a read-only memory (ROM), an electrically programmable ROM, an electrically erasable programmable ROM, a register, a hard disk, a removable disk, a CD-ROM, or any other form of storage medium known in the art.

It should be noted that in the embodiments of the present application, no user sensitive information is involved, and that all user related information is obtained, used, and determined after authorization by the user. In an example, before the user-related information is obtained, a corresponding interface displays prompt information related to obtaining authorization to use the data, where the prompt information is to inform the user the type, range of use, use scenarios, etc., of personal information involved in the present disclosure in an appropriate manner in accordance with the relevant laws and regulations, so that the user can determine whether to agree to the authorization based on the prompt information. It can be understood that the above-mentioned process of notifying and obtaining the authorization of the user is only illustrative and does not constitute a limitation on the implementations of the present disclosure, and other manners that satisfy the relevant laws and regulations may also be applied in the implementations of the present disclosure.

With respect to the above description of the disclosed embodiments, those skilled in the art could implement or use the present application. Various modifications to these embodiments are apparent to those skilled in the art, and the general principle defined herein may be practiced in other embodiments without departing from the spirit or scope of the present application. Therefore, the present application is not limited to the embodiments described herein but is to be accorded with the broadest scope consistent with the principle and novel features disclosed herein.

1. A method for generating an object combination, comprising:
determining, based on category information of each object, a category to which each object belongs; and
generating at least one object combination based on a category association relationship database and the category to which each object belongs, each category association relationship in the category association relationship database comprising at least two categories that satisfy a combination condition and that are determined based on historical interaction result information, the interaction result information being used to reflect historical interactions between the at least two categories, and categories to which at least two objects comprised in each of the at least one object combination belong matching a category association relationship in the category association relationship database.

2. The method according to claim 1, wherein the category association relationship database comprises a first category association relationship, the first category association relationship comprises a first category and a second category, and generating the at least one object combination based on the category association relationship database and the category to which each object belongs comprises:
determining a first object set that consists of objects belonging to the first category among objects;
determining a second object set that consists of objects belonging to the second category among the objects; and
generating, based on the first object set and the second object set, the at least one object combination, wherein each of the at least one object combination comprises any object in the first object set and any object in the second object set.

3. The method according to claim 1, wherein a construction process of the category association relationship database comprises:
obtaining interaction result information corresponding to a third category based on an interaction behavior between an object of the third category and an object of other categories, wherein the interaction result information corresponding to the third category comprises a number of forward interactions and a reverse interaction ratio between the third category and the other categories, the forward interaction refers to that an interaction corresponding to the object belonging to the third category that occurs for a same user is within a preset time period before an interaction corresponding to the object belonging to the other categories that occurs for the user, and that the interaction corresponding to the object belonging to the third category and the interaction corresponding to the object belonging to the other categories are two adjacent interaction behaviors, the reverse interaction ratio refers to a ratio of a number of times that a previous interaction behavior before the interaction corresponding to the object belonging to the other categories occurs is the interaction behavior corresponding to the object belonging to the third category to a number of times that the interaction behavior corresponding to the object belonging to the third category occurs, and an interval time between the time at which the interaction corresponding to the object belonging to the other categories occurs and the time at which the interaction corresponding to the object belonging to the third category occurs is less than or equal to the preset time;
determining, based on the number of forward interactions and the reverse interaction ratio, a fourth category that satisfies the combination condition with the third category, wherein the fourth category belongs to at least one of the other categories; and
recording the third category with each fourth category as a category association relationship in the category association relationship database.

4. The method according to claim 3, wherein determining, based on the number of forward interactions and the reverse interaction ratio, the fourth category that satisfies the combination condition with the third category comprises:
determining, based on the number of forward interactions and the reverse interaction ratio, an association weight between the third category and each of the other categories; and
determining, based on association weights of the other categories, the fourth category that satisfies the combination condition, wherein the combination condition comprises: a preset number of the other categories with highest association weights, or determining the other categories that have association weights greater than a preset weight threshold as the fourth category.

5. The method according to claim 4, wherein determining, based on the association weights of the other categories, the fourth category that satisfies the combination condition comprises:
determining, in response to a fifth category for which the ratio is greater than or equal to a preset ratio threshold existing among the other categories, the fourth category that satisfies the combination condition from the fifth category.

6. The method according to claim 1, wherein objects in the at least one object combination all belong to a same entity.

7. The method according to claim 6, further comprising:
determining, based on a degree of association of each of the at least one object combination, a bundle score for each of the at least one object combination, wherein the degree of association of the object combination represents a ratio or number of times that objects belonging to the object combination within a target entity are combined for marketing, and the bundle score is used to guide display and/or release of a corresponding object combination.

8. (canceled)

9. An electronic device, comprising: a processor and a memory, wherein
the memory is configured to store instructions or a program; and
the processor is configured to execute the instructions or the program in the memory, to cause the electronic device to:
determine, based on category information of each object, a category to which each object belongs; and
generate at least one object combination based on a category association relationship database and the category to which each object belongs, each category association relationship in the category association relationship database comprising at least two categories that satisfy a combination condition and that are determined based on historical interaction result information, the interaction result information being used to reflect historical interactions between the at least two categories, and categories to which at least two objects comprised in each of the at least one object combination belong matching a category association relationship in the category association relationship database.

10. A non-transitory readable medium having instructions or a program stored therein that, when executed on a processor, causes the processor to:
determine, based on category information of each object, a category to which each object belongs; and
generate at least one object combination based on a category association relationship database and the category to which each object belongs, each category association relationship in the category association relationship database comprising at least two categories that satisfy a combination condition and that are determined based on historical interaction result information, the interaction result information being used to reflect historical interactions between the at least two categories, and categories to which at least two objects comprised in each of the at least one object combination belong matching a category association relationship in the category association relationship database.

11. The electronic device according to claim 9, wherein the category association relationship database comprises a first category association relationship, the first category association relationship comprises a first category and a second category, and the instructions or the program causing the electronic device to generate the at least one object combination based on the category association relationship database and the category to which each object belongs further causes the electronic device to:
determine a first object set that consists of objects belonging to the first category among objects;
determine a second object set that consists of objects belonging to the second category among the objects; and
generate, based on the first object set and the second object set, the at least one object combination, wherein each of the at least one object combination comprises any object in the first object set and any object in the second object set.

12. The electronic device according to claim 9, wherein a construction process of the category association relationship database comprises:
obtaining interaction result information corresponding to a third category based on an interaction behavior between an object of the third category and an object of other categories, wherein the interaction result information corresponding to the third category comprises a number of forward interactions and a reverse interaction ratio between the third category and the other categories, the forward interaction refers to that an interaction corresponding to the object belonging to the third category that occurs for a same user is within a preset time period before an interaction corresponding to the object belonging to the other categories that occurs for the user, and that the interaction corresponding to the object belonging to the third category and the interaction corresponding to the object belonging to the other categories are two adjacent interaction behaviors, the reverse interaction ratio refers to a ratio of a number of times that a previous interaction behavior before the interaction corresponding to the object belonging to the other categories occurs is the interaction behavior corresponding to the object belonging to the third category to a number of times that the interaction behavior corresponding to the object belonging to the third category occurs, and an interval time between the time at which the interaction corresponding to the object belonging to the other categories occurs and the time at which the interaction corresponding to the object belonging to the third category occurs is less than or equal to the preset time;
determining, based on the number of forward interactions and the reverse interaction ratio, a fourth category that satisfies the combination condition with the third category, wherein the fourth category belongs to at least one of the other categories; and
recording the third category with each fourth category as a category association relationship in the category association relationship database.

13. The electronic device according to claim 12, wherein the instructions or the program causing the electronic device to determine, based on the number of forward interactions and the reverse interaction ratio, the fourth category that satisfies the combination condition with the third category further causes the electronic device to:
determine, based on the number of forward interactions and the reverse interaction ratio, an association weight between the third category and each of the other categories; and
determine, based on association weights of the other categories, the fourth category that satisfies the combination condition, wherein the combination condition comprises: a preset number of the other categories with highest association weights, or determining the other categories that have association weights greater than a preset weight threshold as the fourth category.

14. The electronic device according to claim 13, wherein the instructions or the program causing the electronic device to determine, based on the association weights of the other categories, the fourth category that satisfies the combination condition further causes the electronic device to:
determine, in response to a fifth category for which the ratio is greater than or equal to a preset ratio threshold existing among the other categories, the fourth category that satisfies the combination condition from the fifth category.

15. The electronic device according to claim 9, wherein objects in the at least one object combination all belong to a same entity.

16. The electronic device according to claim 15, wherein the instructions or the program further causes the electronic device to:
determine, based on a degree of association of each of the at least one object combination, a bundle score for each of the at least one object combination, wherein the degree of association of the object combination represents a ratio or number of times that objects belonging to the object combination within a target entity are combined for marketing, and the bundle score is used to guide display and/or release of a corresponding object combination.

17. The medium according to claim 10, wherein the category association relationship database comprises a first category association relationship, the first category association relationship comprises a first category and a second category, and the instructions or the program causing the processor to generate the at least one object combination based on the category association relationship database and the category to which each object belongs further causes the processor to:
determine a first object set that consists of objects belonging to the first category among objects;
determine a second object set that consists of objects belonging to the second category among the objects; and
generate, based on the first object set and the second object set, the at least one object combination, wherein each of the at least one object combination comprises any object in the first object set and any object in the second object set.

18. The medium according to claim 10, wherein a construction process of the category association relationship database comprises:
obtaining interaction result information corresponding to a third category based on an interaction behavior between an object of the third category and an object of other categories, wherein the interaction result information corresponding to the third category comprises a number of forward interactions and a reverse interaction ratio between the third category and the other categories, the forward interaction refers to that an interaction corresponding to the object belonging to the third category that occurs for a same user is within a preset time period before an interaction corresponding to the object belonging to the other categories that occurs for the user, and that the interaction corresponding to the object belonging to the third category and the interaction corresponding to the object belonging to the other categories are two adjacent interaction behaviors, the reverse interaction ratio refers to a ratio of a number of times that a previous interaction behavior before the interaction corresponding to the object belonging to the other categories occurs is the interaction behavior corresponding to the object belonging to the third category to a number of times that the interaction behavior corresponding to the object belonging to the third category occurs, and an interval time between the time at which the interaction corresponding to the object belonging to the other categories occurs and the time at which the interaction corresponding to the object belonging to the third category occurs is less than or equal to the preset time;
determining, based on the number of forward interactions and the reverse interaction ratio, a fourth category that satisfies the combination condition with the third category, wherein the fourth category belongs to at least one of the other categories; and
recording the third category with each fourth category as a category association relationship in the category association relationship database.

19. The medium according to claim 18, wherein the instructions or the program causing the processor to determine, based on the number of forward interactions and the reverse interaction ratio, the fourth category that satisfies the combination condition with the third category further causes the processor to:
determine, based on the number of forward interactions and the reverse interaction ratio, an association weight between the third category and each of the other categories; and
determine, based on association weights of the other categories, the fourth category that satisfies the combination condition, wherein the combination condition comprises: a preset number of the other categories with highest association weights, or determining the other categories that have association weights greater than a preset weight threshold as the fourth category.

20. The medium according to claim 19, wherein the instructions or the program causing the processor to determine, based on the association weights of the other categories, the fourth category that satisfies the combination condition further causes the processor to:
determine, in response to a fifth category for which the ratio is greater than or equal to a preset ratio threshold existing among the other categories, the fourth category that satisfies the combination condition from the fifth category.

21. The medium according to claim 10, wherein objects in the at least one object combination all belong to a same entity.
